(19) United States
(12) Patent Application Publication
(10) Pub. No.: US 2024/0388860 A1
(43) Pub. Date: Nov. 21, 2024

(54) Visual Indicator for Microphone Placement

(71) Applicant: Apple Inc., Cupertino, CA (US)

(72) Inventors: Symeon Delikaris Manias, Culver City, CA (US); Shai Messingher Lang, Santa Clara, CA (US)

(21) Appl. No.: 18/664,057

(22) Filed: May 14, 2024

Related U.S. Application Data
(60) Provisional application No. 63/467,160, filed on May 17, 2023.

(51) Int. Cl. H04R 29/00; H04R 1/22; H04R 1/32

(52) U.S. Cl. CPC H04R 29/004; H04R 1/222; H04R 1/326; H04R 2499/01

(57) ABSTRACT

A method includes obtaining an acoustic model of an environment. The acoustic model indicates a set of one or more acoustical properties of the environment. The method includes determining a placement location for a microphone within the environment based on the set of one or more acoustical properties of the environment and a pickup pattern of the microphone. The method includes displaying, on the display, a representation of the environment and a visual indicator that is overlaid onto the representation of the environment in order to indicate the placement location for the microphone.

### CROSS-REFERENCE TO RELATED APPLICATION

This application claims the benefit of U.S. Provisional Patent App. No. 63/467,160, filed on May 17, 2023, which is incorporated by reference in its entirety.

### TECHNICAL FIELD

The present disclosure generally relates to a visual indicator for microphone placement.

### BACKGROUND

Some devices include a microphone that can detect sounds within an environment. Placing the microphone at different locations within the environment can result in different sounds being detected. Placing the microphone at different locations within the environment can also result in the sounds being detected with varying degrees.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1L are diagrams of an example operating environment in accordance with some implementations.

FIG. 2 is a diagram of a microphone placement guidance system in accordance with some implementations.

FIG. 3 is a flowchart representation of a method of indicating a placement location for a microphone in accordance with some implementations.

FIG. 4 is a block diagram of a device that determines a placement location for a microphone in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for indicating a placement location for a microphone. In some implementations, a method is performed by a device including a display, an environmental sensor, a non-transitory memory and one or more processors coupled with the display, the environmental sensor and the non-transitory memory. In various implementations, a method includes obtaining an acoustic model of an environment. In some implementations, the acoustic model indicates a set of one or more acoustical properties of the environment. In various implementations, the method includes determining a placement location for a microphone within the environment based on the set of one or more acoustical properties of the environment and a pickup pattern of the microphone. In various implementations, the method includes displaying, on the display, a representation of the environment and a visual indicator that is overlaid onto the representation of the environment in order to indicate the placement location for the microphone.

In accordance with some implementations, a device includes one or more processors, a plurality of sensors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some devices include a microphone that can detect sounds generated in an environment. However, placing the microphone at different locations within the environment can result in different sounds being detected. Moreover, placing the microphone at different locations within the environment can result in the sounds being detected with varying degrees. In order to capture the sounds being generated in an appropriate manner, the microphone may need to be placed at a particular location within the environment.

The present disclosure provides methods, systems, and/or devices for determining a placement location for a microphone and displaying a visual indication of the placement location. The device determines the placement location for the microphone based on an acoustic model of the environment and a pickup pattern of the microphone. The device displays a visual indicator that serves as a guide for placing the microphone at the placement location determined by the device. Placing the microphone at the placement location determined by the device allows the microphone to appropriately capture sounds originating from the environment. The device can automatically determine the placement location for the microphone thereby reducing the need for a user of the device to manually determine the placement location for the microphone.

The acoustic model of the environment may include an acoustic mesh of the environment. The acoustic model indicates how sound propagates within the environment. The device may generate the acoustic model based on dimensions of the environment and placement of objects within the environment. For example, the device may generate the acoustic model of the environment based on a visual mesh of the environment that indicates the dimensions of the environment and the placement of the objects within the environment.

The device may capture images of the environment in order to identify objects that are likely to generate sounds. For example, the device may scan a room to identify musical instruments that are located within the room. The acoustic model of the environment may indicate locations of musical instruments in the environment. For example, the acoustic model may indicate a location of a piano in a room, a location of a drum set in the room, etc. In determining a placement location for the microphone, the device can select a placement location that allows the microphone to sufficiently capture sounds being generated by the sound-generating objects (e.g., the musical instruments).

The device may generate the acoustic model based on material properties of the environment. The material properties may indicate sound absorption qualities of the environment. For example, the material properties may indicate a degree to which a floor and/or furniture in the environment absorbs sounds. The material properties may indicate sound reflectiveness of the environment. For example, the material properties may indicate a degree to which walls and/or wall hangings in the environment reflect sound. As an example, a carpeted floor may absorb sounds to a greater degree than a floor with ceramic tiles. As another example, a room with plastic chairs may reflect more sound than a room with upholstered couches.

The pickup pattern of the microphone may indicate a directivity pattern of the microphone. For example, the pickup pattern may indicate whether the microphone is a unidirectional microphone, a bidirectional microphone, an omnidirectional microphone, a cardioid microphone, a subcardioid microphone, etc. The device may determine a model and/or a serial number of the microphone, and use the model and/or the serial number to lookup the pickup pattern of the microphone from a database that stores pickup patterns of various microphones.

The acoustic model may indicate placement locations of other microphones in the environment. The device can determine the placement location of a particular microphone based on respective placement locations of other microphones. For example, if another microphone is placed adjacent to a set of drums then the current microphone can be placed away from the set of drums because the current microphone may not need to capture sounds emanating from the set of drums.

The device may perform simulations that illustrate how sounds captured by the microphone may sound were the microphone to be placed at different locations. For example, prior to placing the microphone at a first location within the environment, the user can play a first simulation that shows how well the microphone would capture sounds from the first location. If the simulation indicates that the microphone would not appropriately capture sounds from the first location, the user can place the microphone at an alternative second location indicated by the device.

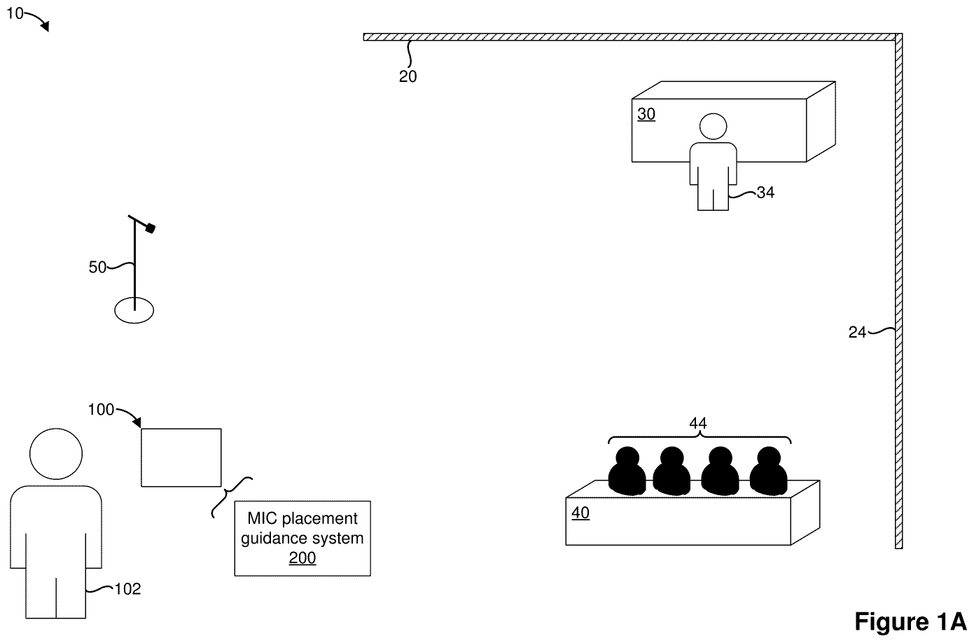

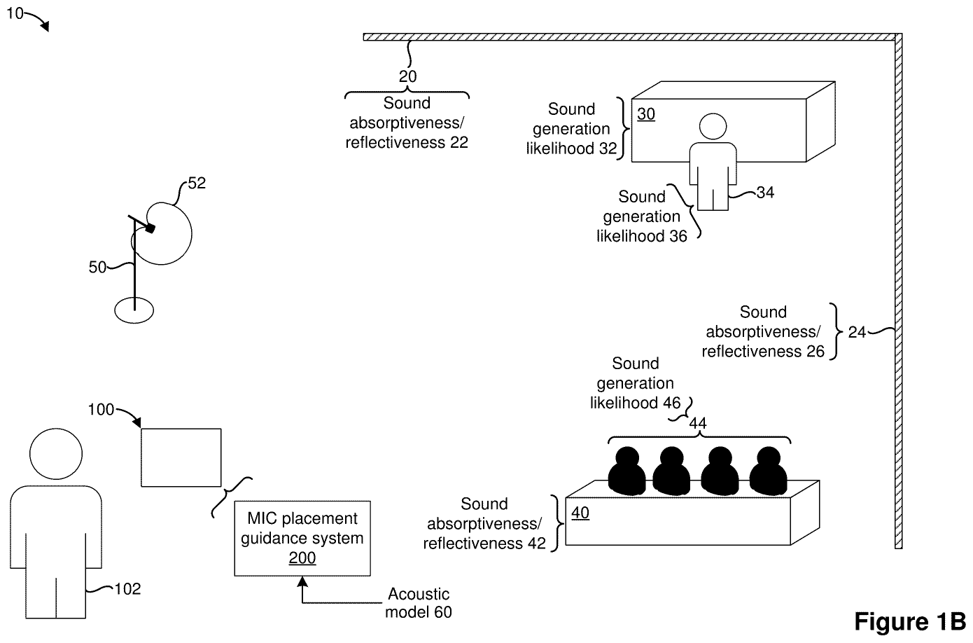

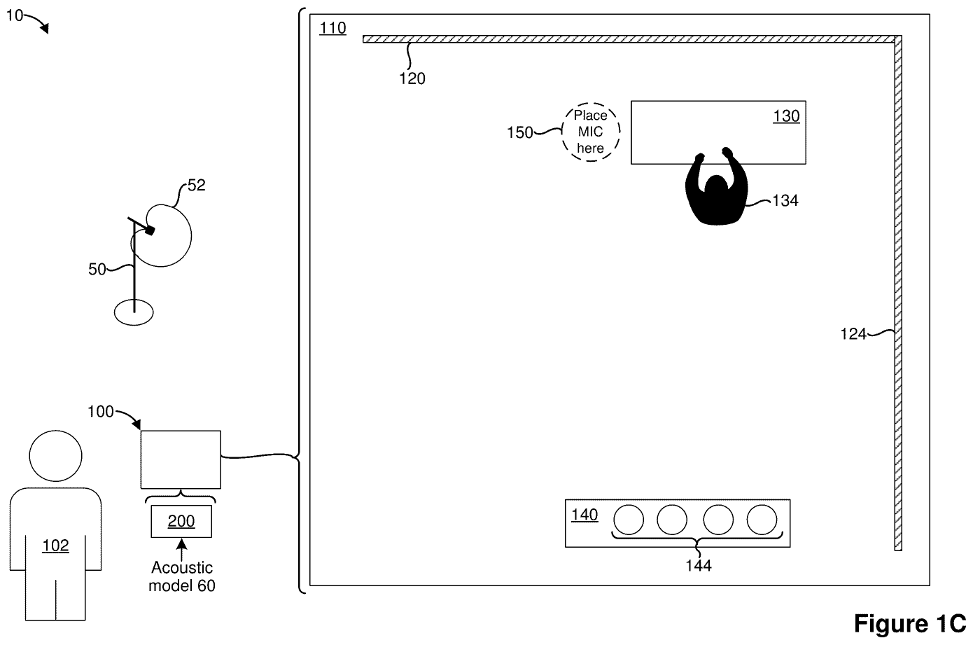

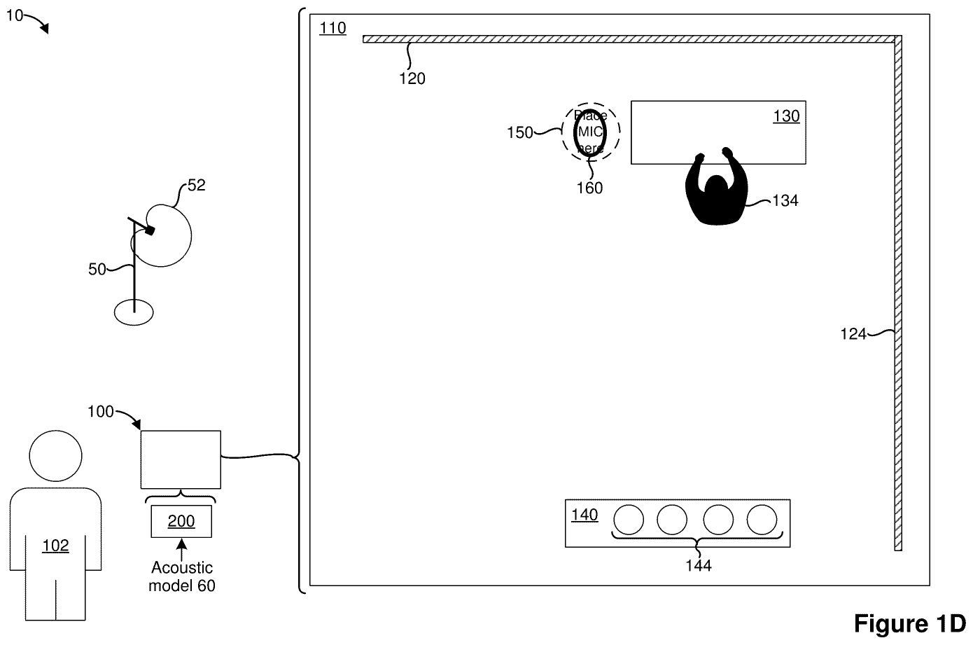

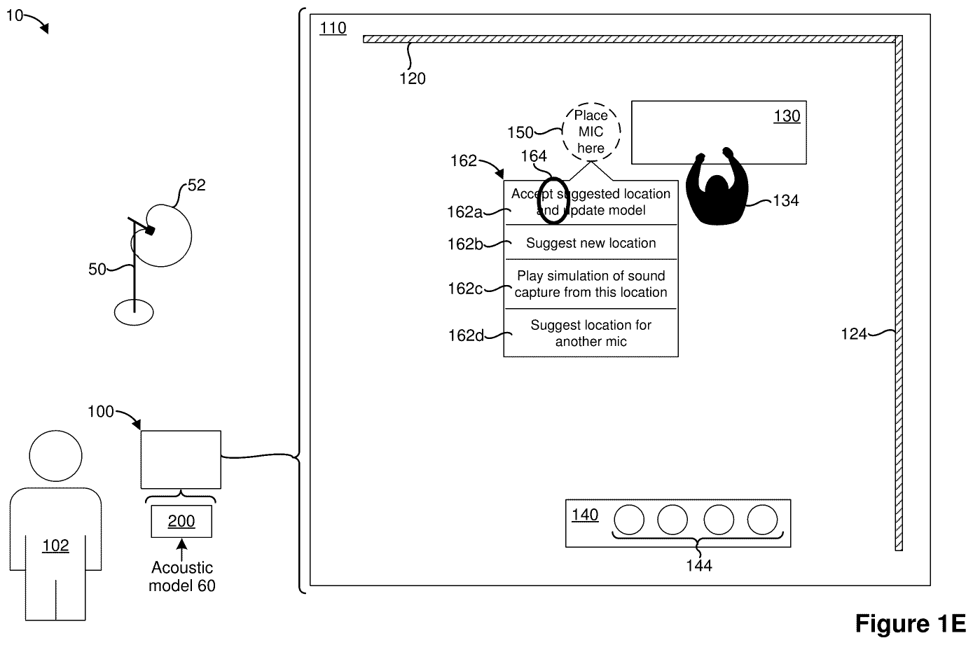

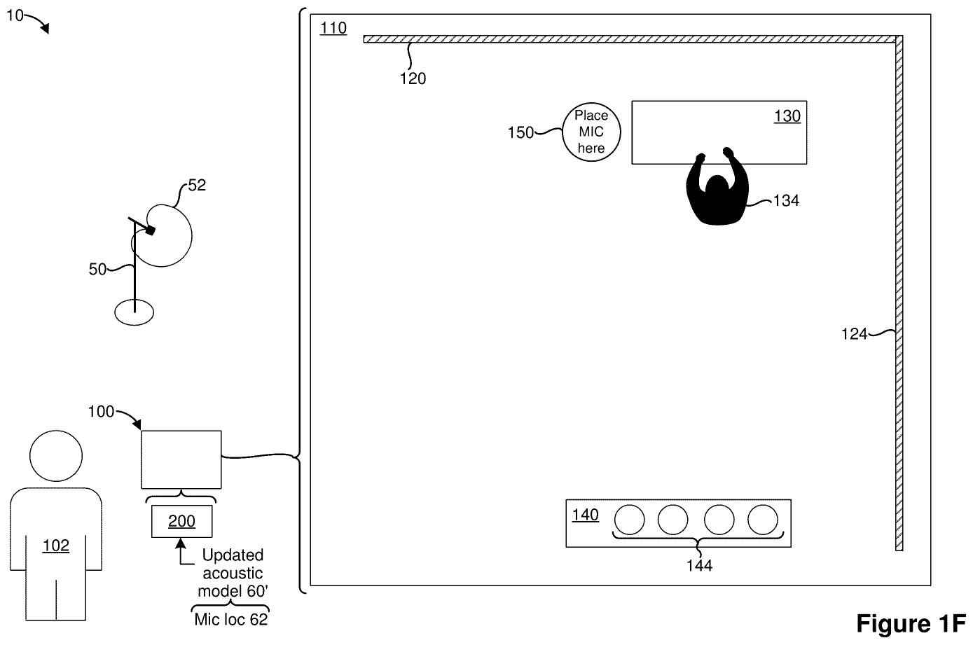

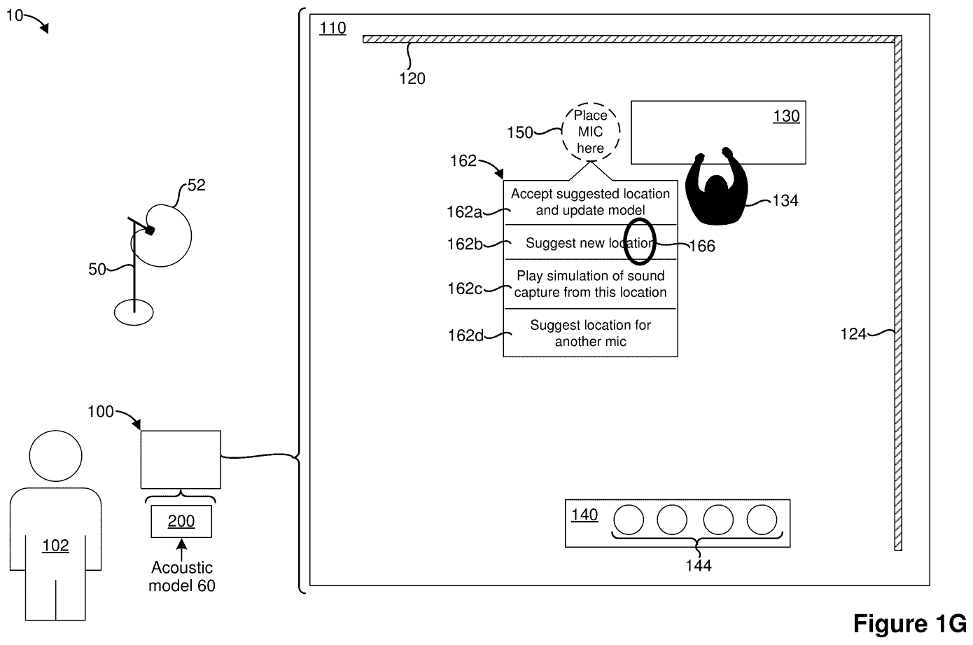

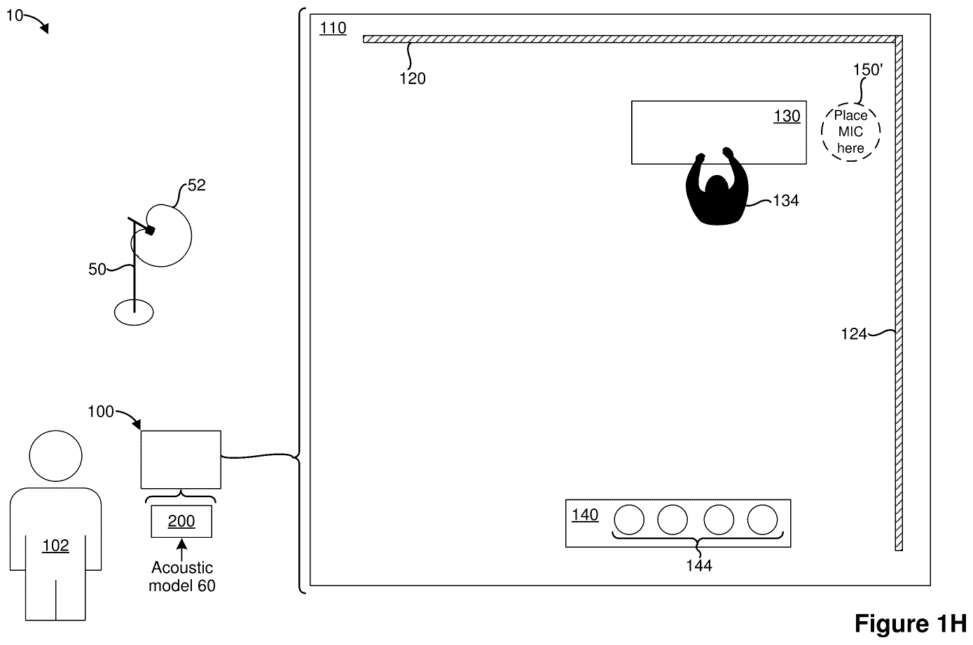

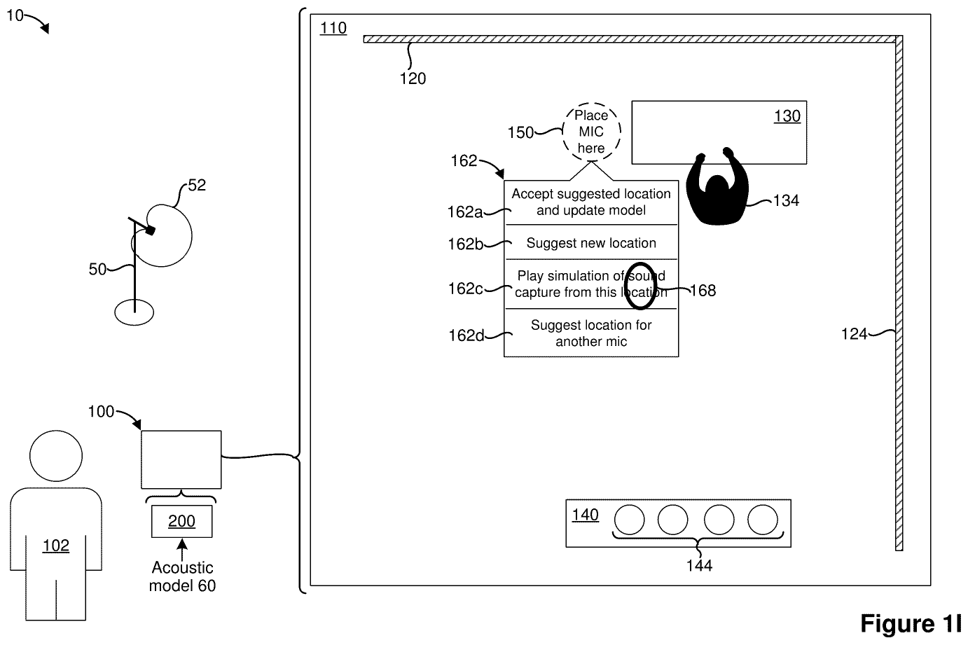

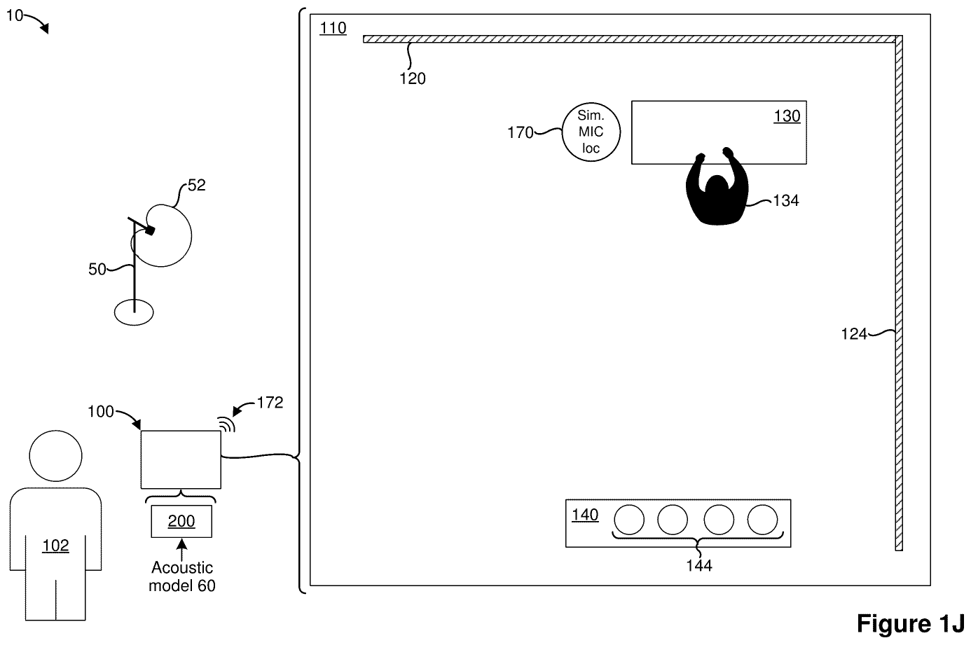

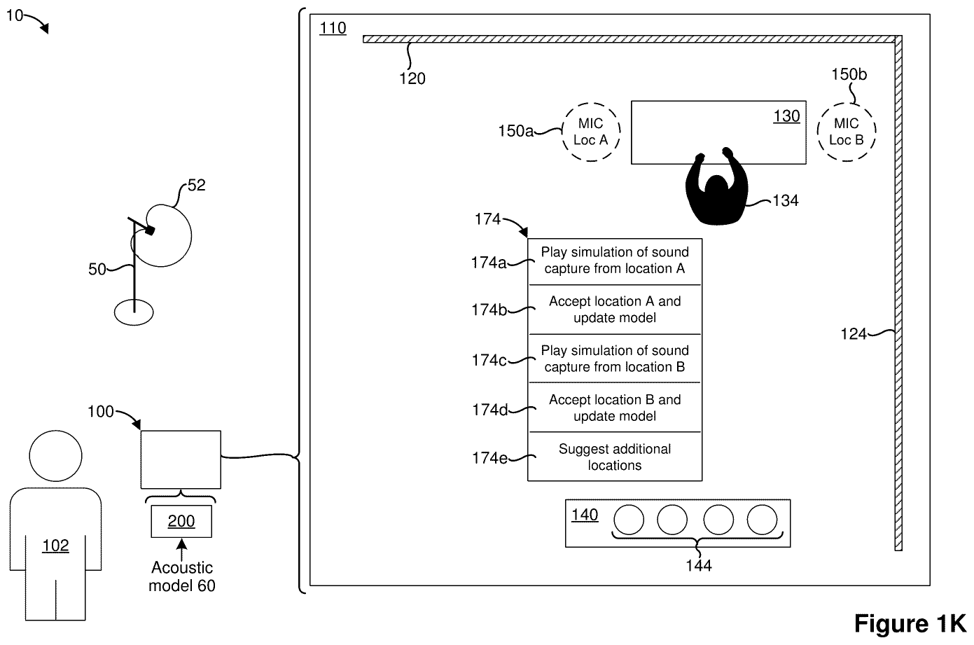

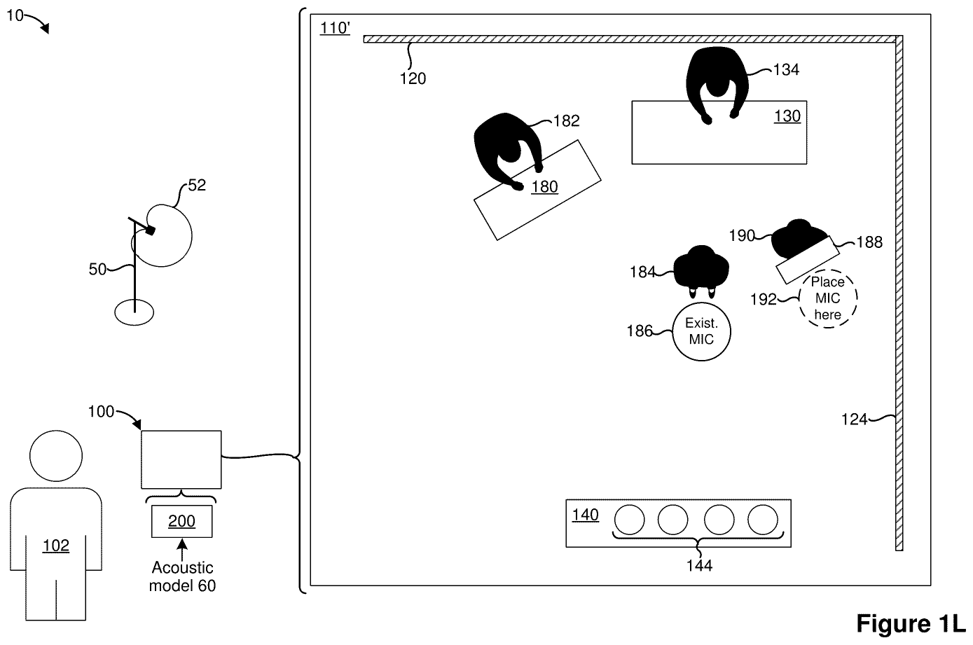

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the physical environment 10 includes a front wall 20, a side wall 24, a piano 30, a piano player 34, a bench 40, audience members 44, a microphone 50, an electronic device 100 and a user 102 of the electronic device 100. In some implementations, the physical environment 10 represents an enclosed space such as a room (e.g., a living room in a home), a banquet hall, a concert venue, a stadium, etc. In some implementations, the physical environment 10 represents an open space such as a park, an amphitheater, a backyard of a home, etc.

In various implementations, the electronic device 100 includes a microphone placement guidance system 200 (“system 200”, hereafter for the sake of brevity) that provides guidance to the user 102 in placing the microphone 50 at a suitable location within the physical environment 10. In some implementations, the system 200 automatically determines a suitable location for placing the microphone 50 within the physical environment 10, and the electronic device 100 displays a visual indicator that indicates that location to the user 102. In various implementations, automatically determining the location for placing the microphone 50 reduces the need for the user 102 to manually determine the location for placing the microphone 50. In some implementations, automatically determining the location for placing the microphone 50 reduces the need for trial-and-error where the user 102 physically places the microphone 50 at various locations within the physical environment 10 in order to select a seemingly appropriate location for the microphone 50. Automatically determining the placement location for the microphone 50 reduces unsuitable audio capture by the microphone 50 and tends to reduce a power consumption of the electronic device 100 associated with playing unsuitable audio captures.

Referring to FIG. 1B, the system 200 obtains an acoustic model 60 of the physical environment 10. In various implementations, the acoustic model 60 indicates how sound propagates within the physical environment 10. In some implementations, the acoustic model 60 indicates respective locations of various objects within the physical environment 10. In some implementations, the acoustic model 60 indicates respective sound absorptiveness of the objects in the physical environment 10. For example, the acoustic model 60 may include sound absorptiveness values that characterize a degree to which corresponding objects absorb sounds. In some implementations, the acoustic model 60 indicates respective sound reflectiveness of the objects in the physical environment 10. For example, the acoustic model 60 may include sound reflectiveness values that characterize a degree to which corresponding objects reflect sounds. In the example of FIG. 1B, the acoustic model 60 includes a sound absorptiveness/reflectiveness value 22 for the front wall 20, a sound absorptiveness/reflectiveness value 26 for the side wall 24, and a sound absorptiveness/reflectiveness value 42 for the bench 40.

In some implementations, the system 200 determines the sound absorptiveness/reflectiveness value for an object based on an image analysis of the object. For example, the system 200 identifies an object type of the object and retrieves the sound absorptiveness/reflectiveness value for that object type from a datastore that stores sound absorptiveness/reflectiveness values for various object types. In some implementations, the system 200 identifies a material that the object is made of, and the system 200 retrieves the sound absorptiveness/reflectiveness value for that material from a datastore that stores sound absorptiveness/reflectiveness values for various materials.

In some implementations, the acoustic model 60 indicates respective sound generation likelihoods of the objects in the physical environment 10. For example, the acoustic model 60 may include sound generation likelihood values that indicate respective probabilities of the corresponding objects generating sounds. In some implementations, the system 200 determines the sound generation likelihood of an object based on an object type of the object. For example, the sound generation likelihood of a musical instrument is greater than the sound generation likelihood of furniture. As another example, the sound generation likelihood of a first musical instrument may be greater than the sound generation likelihood of a second musical instrument, for example, because the first musical instrument may be a core musical instrument (e.g., a lead musical instrument) and the second musical instrument may be a supporting musical instrument. In some implementations, the system 200 determines the sound generation likelihood of a person based on a body pose of the person. For example, the sound generation likelihood of a person who has started moving (e.g., shifted in his/her seat, started a hand gesture, etc.) may be greater than the sound generation likelihood of a person who is stationary. In the example of FIG. 1B, the acoustic model 60 includes a sound generation likelihood value 32 for the piano 30, a sound generation likelihood value 36 for the piano player 34, and a sound generation likelihood value 46 for the audience members 44.

In some implementations, the system 200 generates the sound generation likelihood values 32, 36 and/or 46 based on historical environmental data regarding the physical environment 10. In some implementations, the historical environmental data includes images of the environment and/or audio data corresponding to sounds emanating from the physical environment 10. In some implementations, the system 200 utilizes the historical environmental data to identify objects, persons and/or locations within the physical environment 10 that have historically generated sounds. For example, the historical environmental data may indicate that persons sitting on the bench 40 have historically not spoken or sung while the piano 30 is being played. As such, the system 200 may set the sound generation likelihood value 46 for the audience members 44 to a relatively low number. For example, the system 200 may set the sound generation likelihood value 46 to be less than a sound generation likelihood threshold, for example, to 0.05 indicating that the likelihood of the audience members 44 generating sound is less than five percent. As another example, the system 200 may set the sound generation likelihood value 36 to a moderate value such as 0.30 based on the historical environmental data indicating that the piano player 34 sings about thirty percent of the time while playing the piano 30. As yet another example, the system 200 may set the sound generation likelihood value 32 to a relatively high value such as 0.85 based on the historical environmental data indicating that the piano player 34 plays the piano 30 about eighty-five percent of the time when sitting in front of the piano 30.

In various implementations, the system 200 determines a pickup pattern 52 associated with the microphone 50. The pickup pattern 52 is a function of a directionality of the microphone 50. The microphone 50 can be a unidirectional microphone, a bidirectional microphone or an omnidirectional microphone. In the example of FIG. 1B, the microphone 50 is a unidirectional microphone and the pickup pattern 52 is a cardioid pickup pattern. As such, the microphone 50 is suitable for capturing sounds emanating from a single source that is situated in front of the microphone 50. The pickup pattern 52 makes the microphone 50 less suitable for capturing sounds that originate from sides of the microphone 50 and unsuitable for capturing sounds that originate behind the microphone 50. Other example pickup patterns include hypercardioid, figure-of-eight, half-cardioid, omnidirectional and supercardioid.

Referring to FIG. 1C, in various implementations, the system 200 determines a location for placing the microphone 50 within the physical environment 10 based on the acoustic model 60 of the physical environment 10 and the pickup pattern 52 of the microphone 50. In some implementations, the electronic device 100 displays an environment representation 110 that represents the physical environment 10 shown in FIGS. 1A and 1B. In the example of FIG. 1C, the environment representation 110 is a top-down view of the physical environment 10. As can be seen in FIG. 1C, the environment representation 110 includes representations of objects that are in the physical environment 10. To that end, the environment representation 110 includes a front wall representation 120 that represents the front wall 20, a side wall representation 124 that represents the side wall 24, a piano representation 130 that represents the piano 30, a piano player representation 134 that represents the piano player 34, a bench representation 140 that represents the bench 40, and audience member representations 144 that represent the audience members 44. In some implementations, the environment representation 110 includes a pass-through of the physical environment 10, and the representations 120, 124, 130, 134, 140 and 144 include pass-through representations of the front wall 20, the side wall 24, the piano 30, the piano player 34, the bench 40 and the audience members 44, respectively.

As illustrated in FIG. 1C, the electronic device 20 displays a visual indicator 150 that indicates the location that the system 200 has automatically determined for placing the microphone 50. In some implementations, the visual indicator 150 includes an augmented reality (AR) element that the electronic device 100 overlays onto a pass-through of the physical environment 10. In some implementations, the AR element includes an AR microphone. In the example of FIG. 1C, the system 200 determines that the microphone 50 is to be placed adjacent to the piano 30 and on the left side of the piano 30. In some implementations, the system 200 automatically selects the location adjacent to the piano 30 so that the microphone 50 can appropriately capture sounds generated by the piano 30. In some implementations, the system 200 selects the location adjacent to the piano 30 because the sound generation likelihood value 32 of the piano 30 is greater than the sound generation likelihood value 36 of the piano player 34 and the sound generation likelihood value 46 of the audience members 44. More generally, in various implementations, the system 200 recommends a placement location that is adjacent to an object with the greatest likelihood of generating sound.

In the example of FIG. 1C, the system 200 recommends placing the microphone 50 to the left of the piano 30 instead of placing the microphone 50 to the right of the piano 30. In some implementations, the system 200 recommends placing the microphone 50 to the left of the piano 30 based on the sound absorptiveness/reflectiveness value 22 of the front wall 20 and the sound absorptiveness/reflectiveness value 26 of the side wall 24. For example, the system 200 determines that the left side of the piano 30 may result in a better audio capture than the right side of the piano 30 due to fewer reflections from the side wall 24. More generally, in various implementations, the system 200 determines a placement location that is likely to result in a direct-to-reverberant ratio (DRR) that is less than a threshold DRR. For example, the system 200 determines candidate placement locations and respective DRRs for the candidate placement locations. In this example, the system 200 selects a particular one of the candidate placement locations that results in the smallest DRR value.

In some implementations, the visual indicator 150 indicates a direction for pointing the microphone 50. The pickup pattern 52 of the microphone 50 indicates a directionality of the microphone 50, and the system 200 automatically determines the direction for pointing the microphone 50 based on the directionality indicated by the pickup pattern 52. In the example of FIG. 1C, the pickup pattern 52 of the microphone 50 indicates that the microphone 50 is a unidirectional microphone. As such, the visual indicator 150 recommends pointing the microphone 50 downwards towards the piano 30 so that the microphone 50 can appropriately capture the sounds generated by the piano 30. In some implementations, the visual indicator 150 has a shape that corresponds to (e.g., matches or is similar to) a shape of the pickup pattern 52. In some implementations, the visual indicator 150 has a conical shape. For example, the visual indicator 150 may be an AR cone with a mouth that opens up towards the piano 30.

Referring to FIG. 1D, the electronic device 100 detects a user input 160 directed to the visual indicator 150. In some implementations, the electronic device 100 displays the visual indicator 150 on a touchscreen display, and the user input 160 includes a tap at a display location corresponding to the visual indicator 150. In some implementations, the electronic device 100 displays the visual indicator 150 on a see-through display, and the user input 160 includes a three-dimensional gesture that points to a display location corresponding to the visual indicator 150.

Referring to FIG. 1E, in some implementations, the electronic device 100 displays a menu 162 in response to detecting the user input 160 directed to the visual indicator 150. In some implementations, the menu 162 includes various options that relate to the placement location indicated by the visual indicator 150. In the example of FIG. 1E, the menu 162 includes a first option 162a for accepting the recommended location and updating the acoustic model 60, a second option 162b for recommending a new location, a third option 162c for playing a simulation of sound capture from the recommended location, and a fourth option 162d for recommending a location for another microphone.

In the example of FIG. 1E, the electronic device 100 detects a user input 164 directed to the first option 162a. The user input 164 corresponds to a request to accept the placement location indicated by the visual indicator 150 and update the acoustic model 60. Referring to FIG. 1F, in response to detecting the user input 164 (shown in FIG. 1E), the electronic device 100 accepts the recommended location and updates the acoustic model 60 to generate an updated acoustic model 60′ that indicates a microphone location 62 indicated by the visual indicator 150. As can be seen in FIG. 1F, the electronic device 100 changes a visual appearance of the visual indicator 150 from using dashed lines to using solid lines in order to indicate that the user 102 has accepted the recommended location for placing the microphone 50.

Referring to FIG. 1G, the electronic device 100 detects a user input 166 directed to the second option 162b. The user input 166 corresponds to a request to determine an alternate location for placing the microphone 50. Referring to FIG. 1H, in response to detecting the user input 166 (shown in FIG. 1G), the electronic device 100 automatically determines another location for placing the microphone 50 and displays a visual indicator 150′ at the other location. In the example of FIG. 1H, the other location indicated by the visual indicator 150′ is on the right side of the piano 30. The user 102 can tap on the visual indicator 150′ to trigger the electronic device 100 to display a menu similar to the menu 162 shown in FIG. 1G and get a recommendation for yet another location.

Referring to FIG. 1I, the electronic device 100 detects a user input 168 directed to the third option 162c. The user input 168 corresponds to a request to play a simulation of what captured audio would sound like if the microphone 50 was placed at the location indicated by the visual indicator 150. Referring to FIG. 1J, in response to detecting the user input 168 (shown in FIG. 1I), the electronic device 100 plays a simulated audio output 172 that indicates what audio captured by the microphone 50 would sound like if the microphone 50 was placed at a simulated microphone location 170 that corresponds to the location indicated by the visual indicator 150 shown in FIG. 1I.

Referring to FIG. 1K, in some implementations, the system 200 suggests multiple potential locations for placing the microphone 50 and the user 102 selects one of the potential locations suggested by the system 200. In the example of FIG. 1K, the electronic device 100 displays respective visual indicators for a first suggested microphone location 150a and a second suggested microphone location 150b. The electronic device 100 can display a menu 174 that allows the user 102 to further explore the suggested microphone locations 150a and 150b. The menu 174 may include a first option 174a for playing a simulated sound capture from the first suggested microphone location 150a, a second option 174b for accepting the first suggested microphone location 150a, a third option 174c for playing a simulated sound capture from the second suggested microphone location 150b, a fourth option 174d for accepting the second suggested microphone location 150b, and a fifth option 174e for suggesting additional locations.

Selecting the first option 174a triggers the electronic device 100 to play an audio clip that indicates how audio captured from the first suggested microphone location 150a would sound. Selecting the second option 174b triggers the system 200 to update the acoustic model 60 to indicate that the microphone 50 has been placed at the first suggested microphone location 150a. Selecting the third option 174c triggers the electronic device 100 to play an audio clip that indicates how audio captured from the second suggested microphone location 150b would sound. Selecting the fourth option 174d triggers the system 200 to update the acoustic model 60 to indicate that the microphone 50 has been placed at the second suggested microphone location 150b. Selecting the fifth option 174e triggers the system 200 to determine suggested microphone locations in addition to the first and second suggested microphone locations 150a and 150b.

FIG. 1L illustrates another environment representation 110′ that includes representations of additional physical objects and persons. In the example of FIG. 1L, the other environment representation 110′ includes a drum set representation 180 that represents a physical drum set, a drummer representation 182 that represents a drummer playing the physical drum set, a singer representation 184 that represents a person singing, an existing microphone representation 186 that represents a physical microphone placed in front of the person singing, a guitar representation 188 that represents a physical guitar, and a guitarist representation 190 that represents a guitarist playing the guitar.

In the example of FIG. 1L, the system 200 determines a location in front of the guitar as the most suitable location for placing the microphone 50. The system 200 may determine the location in front of the guitar as the appropriate location for placing the microphone 50 based on expected amplitudes of sounds originating from the guitar, the drum set and the piano. For example, the system 200 determines that sounds originating from the guitar are expected to have a lower amplitude than sounds originating from the drum set and the piano. As such, in this example, the system 200 determines that the sounds originating from the guitar require the most amplification. As shown in FIG. 1L, the electronic device 100 displays a visual indicator 192 to indicate that the microphone 50 is to be placed in front of the guitar. More generally, in various implementations, the system 200 determines a placement location for a new microphone based on a placement location of an existing microphone. In some implementations, the acoustic model 60 indicates placement location(s) of existing microphone(s). Moreover, in some implementations, the acoustic model 60 indicates expected amplitudes of sounds from various objects in the physical environment 10.

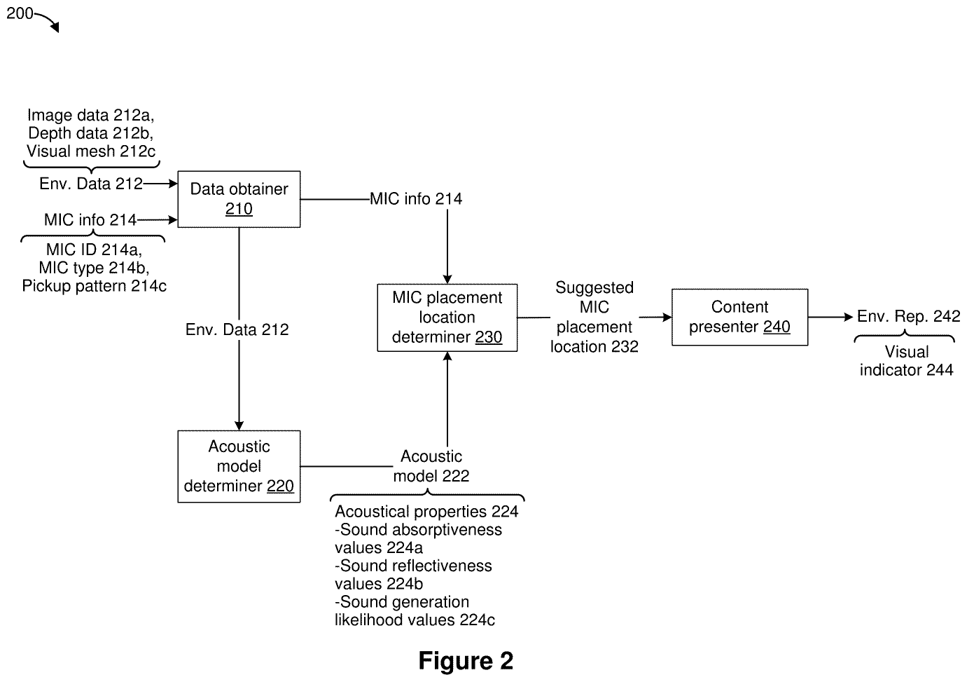

FIG. 2 is a block diagram of the system 200 in accordance with some implementations. In some implementations, the system 200 resides at the electronic device 100 shown in FIGS. 1A-1L. In various implementations, the system 200 includes a data obtainer 210, an acoustic model determiner 220, a microphone placement location determiner 230 and a content presenter 240.

In various implementations, the data obtainer 210 obtains environmental data 212 associated with a physical environment (e.g., the physical environment 10 shown in FIGS. 1A-1L). In some implementations, the environmental data 212 includes image data 212a captured by an image sensor (e.g., a set of one or more images captured by a visible light camera and/or an infrared (IR) camera). In some implementations, the environmental data 212 includes depth data 212b captured by a depth sensor (e.g., depth camera). In some implementations, the environmental data 212 includes a visual mesh 212c of the physical environment. The visual mesh indicates dimensions and/or locations of physical objects in the physical environment. In some implementations, the visual mesh 212c indicates dimensions and/or positions of inanimate objects such as musical instruments and furniture (e.g., the front wall 20, the side wall 24, the piano 30 and the bench 40 shown in FIG. 1A). In some implementations, the visual mesh 212c indicates dimensions and/or positions of persons such as music players playing the musical instruments and audience members listening to the music being played (e.g., the piano player 34 and the audience members 44 shown in FIG. 1A). In some implementations, the data obtainer 210 generates the visual mesh 212c based on the image data 212a and/or the depth data 212b.

In some implementations, the data obtainer 210 obtains microphone information 214 regarding a microphone that is to be placed in the physical environment (e.g., the microphone 50 shown in FIGS. 1A-1L). In some implementations, the microphone information 214 includes a microphone identifier 214a that identifies the microphone. The microphone identifier 214a may include a serial number, a model number, a bar code number, etc. that can be used to lookup a pickup pattern (e.g., a directivity pattern) for the microphone. In some implementations, the microphone information 214 indicates a microphone type 214b. The microphone type 214b may indicate the pickup pattern of the microphone. For example, the microphone type 214b may indicate whether the microphone is a unidirectional microphone, a bidirectional microphone or an omnidirectional microphone. In some implementations, the microphone information 214 indicates a pickup pattern 214c of the microphone. For example, the microphone information 214 may indicate whether the microphone has a cardioid pickup pattern (e.g., a heart-shaped pickup pattern), a hypercardioid pickup pattern, a figure-of-eight pickup pattern, a half-cardioid pickup pattern, an omnidirectional pickup pattern, a supercardioid pickup pattern or a pickup pattern with another shape. In some implementations, the data obtainer 210 utilizes the microphone identifier 214a and/or the microphone type 214b to look up the pickup pattern 214c from a datastore that stores pickup patterns for various microphones.

In various implementations, the acoustic model determiner 220 determines an acoustic model 222 of the physical environment based on the environmental data 212 regarding the physical environment. The acoustic model 222 indicates a set of one or more acoustical properties 224 regarding the physical environment. The acoustical properties 224 indicate how sound propagates within the physical environment. In some implementations, the acoustical properties 224 include sound absorptiveness values 224a that indicate whether corresponding objects absorb sounds and a degree to which the corresponding objects absorb sounds. In some implementations, the acoustical properties 224 include sound reflectiveness values 224b that indicate whether corresponding objects reflect sounds and a degree to which the corresponding objects reflect sounds. For example, the sound absorptiveness values 224a and the sound reflectiveness values 224b include the sound absorptiveness/reflectiveness values 22, 26 and 42 shown in FIG. 1B.

In some implementations, the acoustic model determiner 220 determines the sound absorptiveness values 224a and/or the sound reflectiveness values 224b based on the environmental data 212. For example, the acoustic model determiner 220 performs image analysis on the image data 212a to identify a material of an object and looks up a sound absorptivity coefficient and/or a sound reflectivity coefficient of the material in a datastore that stores sound absorptivity coefficients and/or sound reflectivity coefficients for various materials.

In some implementations, the acoustical properties 224 include sound generation likelihood values 224c that indicate respective likelihoods of corresponding objects generating sounds. For example, the acoustical properties 224 include the sound generation likelihood values 32, 36 and 46 shown in FIG. 1B. In some implementations, the acoustic model determiner 220 determines the sound generation likelihood values 224c based on historical audio data that indicates a number of times that corresponding objects generated sound within a given period of time.

In various implementations, the microphone placement location determiner 230 (“placement determiner 230” hereafter) determines a suggested microphone placement location 232 (“placement location 232” hereafter) based on the acoustic model 222 of the physical environment and the pickup pattern 214c of the microphone. In some implementations, the acoustic model 222 indicates an object that is most likely to generate sounds, and the placement determiner 230 selects the placement location 232 to be a location that is closest to the object. For example, the placement determiner 230 selects the placement location 232 adjacent to an object with the greatest sound generation likelihood value 224c.

In some implementations, the acoustic model 222 indicates surfaces that reflect more than a threshold amount of sound, and the placement determiner 230 selects the placement location 232 to be a location that is near a likely sound source and distant from an overly reflective surface in order to avoid capturing an echo. For example, the placement determiner 230 selects the placement location 232 to be near an object with the greatest sound generation likelihood value 224c and distant from an object with the greatest sound reflectiveness value 224b.

In some implementations, the acoustic model 222 indicates surfaces that absorb more than a threshold amount of sound, and the placement determiner 230 selects the placement location 232 to be a location that is near a likely sound source and a surface that absorbs sound in order to reduce capturing echoes. For example, the placement determiner 230 selects the placement location 232 to be near an object with the greatest sound generation likelihood value 224c and relatively close to an object with the greatest sound absorptiveness value 224a.

In some implementations, the placement determiner 230 generates a set of candidate placement locations and selects the placement location 232 from the set of candidate placement locations. In some implementations, the placement determiner 230 generates respective quality scores for the candidate placement locations and selects one of the candidate placement locations based on the quality scores. In some implementations, the quality score of a candidate placement location indicates an expected quality of sound captured from that candidate placement location. In such implementations, the placement determiner 230 selects the candidate placement location with the greatest quality score as the placement location 232 for the microphone. In some implementations, the quality scores include expected DRR values. In such implementations, the placement determiner 230 selects the candidate placement location with the smallest DRR value.

In some implementations, the placement determiner 230 utilizes a machine-learned model to determine the placement location 232. The machine-learned model may include a set of one or more neural networks that accepts the acoustic model 222 and the pickup pattern 214c as inputs, and outputs the placement location 232 for the microphone.

In some implementations, the content presenter 240 presents an environment representation 242 that represents the physical environment in which the microphone is to be placed. For example, the content presenter 240 presents the environment representation 110 shown in FIG. 1C. In some implementations, the environment representation 242 includes a map of the physical environment. In some implementations, the environment representation 242 includes a top-down view of the physical environment. In some implementations, the environment representation 242 includes a pass-through of the physical environment (e.g., an optical pass-through or a video pass-through).

In some implementations, the content presenter 240 overlays a visual indicator 244 on top of the environment representation 242. The visual indicator 244 indicates the placement location 232 for placing the microphone. In some implementations, the environment representation 242 is a pass-through of the physical environment and the visual indicator 244 is an AR element that is overlaid onto the pass-through of the physical environment. In some implementations, the visual indicator 244 indicates a direction for pointing the microphone. The placement determiner 230 may determine the direction for pointing the microphone based on the pickup pattern 214c of the microphone.

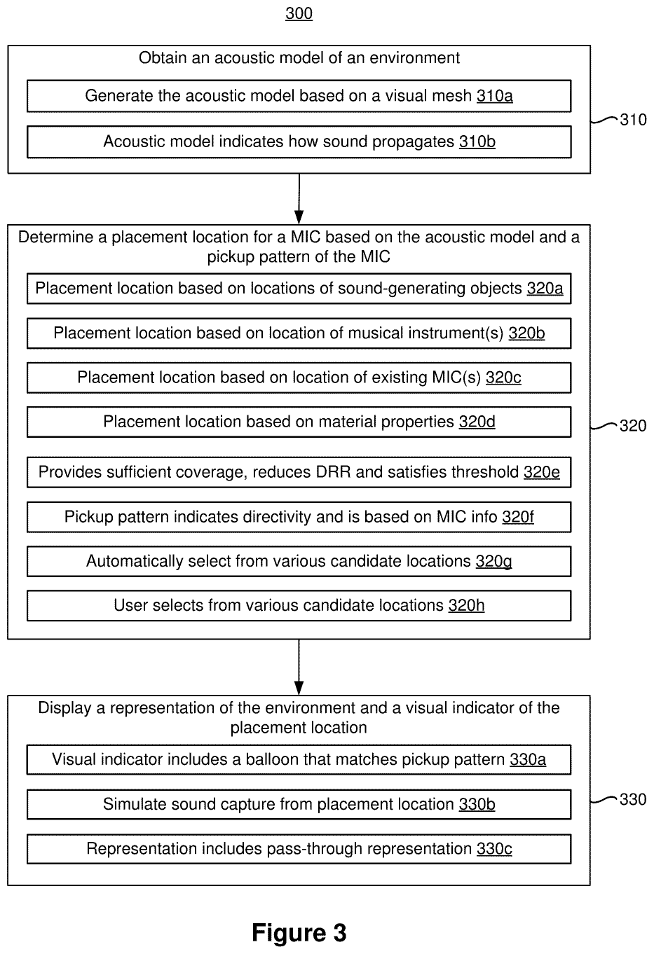

FIG. 3 is a flowchart representation of a method 300 for indicating a placement location for a microphone. In various implementations, the method 300 is performed by the electronic device 100 shown in FIGS. 1A-1L and/or the system 200 shown in FIGS. 1A-1L. In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes obtaining an acoustic model of an environment. In some implementations, the environment includes a physical environment. In some implementations, the environment includes an enclosed space such as a room, a banquet hall, a stage, etc. In some implementations, the environment includes an open space such as a park, a backyard of a home, an open amphitheater, etc. In some implementations, the device receives the acoustic model. Alternatively, in some implementations, the device generates the acoustic model, for example, based on environmental data associated with the physical environment. For example, as shown in FIG. 2, the acoustic model determiner 220 generates the acoustic model 222 based on the environmental data 212.

As represented by block 310a, in some implementations, obtaining the acoustic model includes obtaining a visual mesh that indicates dimensions of the environment and placements of objects in the environment, and generating the acoustic model based on the visual mesh of the environment. For example, as shown in FIG. 2, in some implementations, the data obtainer 210 obtains the visual mesh 212c and the acoustic model determiner 220 utilizes the visual mesh 212c to generate the acoustic model 222.

In some implementations, the acoustic model indicates a set of one or more acoustical properties of the environment. As represented by block 310b, in some implementations, the set of one or more acoustical properties indicates how sound propagates within the environment. In some implementations, the acoustical properties indicate which objects absorb sounds and a degree to which the objects absorb sounds. For example, as shown in FIG. 2, the acoustical properties 224 include the sound absorptiveness values 224a. In some implementations, the acoustical properties indicate which objects reflect sounds and a degree to which the objects reflect sounds. For example, as shown in FIG. 2, the acoustical properties 224 include the sound reflectiveness values 224b. In some implementations, the acoustical properties indicate which objects are likely to generate sounds and expected amplitudes of the sounds. For example, as shown in FIG. 2, the acoustical properties 224 include the sound generation likelihood values 224c.

In some implementations, the acoustic model indicates respective locations of objects that are capable of generating sounds. For example, in some implementations, the acoustic model indicates respective locations of musical instruments within the environment. As shown in FIG. 1B, the acoustic model 60 indicates a location of the piano 30 and the sound generation likelihood value 32 for the piano 30. In some implementations, the acoustic model indicates respective locations of objects that are capable of absorbing or reflecting sounds. For example, in some implementations, the acoustic model indicates respective absorptiveness values and/or respective reflectiveness values for objects. As shown in FIG. 1B, the acoustic model 60 includes the sound absorptiveness/reflectiveness values 22, 26 and 42 for the front wall 20, the side wall 24 and the bench 40, respectively. In some implementations, the acoustical properties are a function of material properties of the environment. For example, as discussed in relation to FIG. 1B the sound absorptiveness/reflectiveness values 22, 26 and 42 may be a function of the materials that the front wall 20, the side wall 24 and the bench 40, respectively, are composed of. In some implementations, the acoustic model indicates respective locations of existing microphones in the physical environment. For example, as shown in FIG. 1L, the environment representation 110′ includes the existing microphone representation 186 and the acoustic model 60 may indicate a location of the existing microphone.

As represented by block 320, in various implementations, the method 300 includes determining a placement location for a microphone within the environment based on the set of one or more acoustical properties of the environment and a pickup pattern of the microphone. For example, as shown in FIG. 1C, the system 200 determines the placement location for the microphone 50 based on the acoustic model 60 and the pickup pattern 52 of the microphone 50. As another example, as shown in FIG. 2, the placement determiner 230 determines the placement location 232 based on the acoustical properties 224 indicated by the acoustic model 222 and the pickup pattern 214c.

As represented by block 320a, in some implementations, the set of one or more acoustical properties indicates respective locations of objects that are capable of generating sounds. In such implementations, determining the placement location for the microphone includes selecting the placement location based on the respective locations of the objects that are capable of generating sounds in order to capture the sounds that the objects are capable of generating. In some implementations, the acoustic model indicates locations of musical instruments. For example, as discussed in relation to FIG. 2, the acoustic model 60 may indicate a location of the piano 30 within the physical environment 10 and the sound generation likelihood value 32 for the piano 30. In some implementations, the device selects the placement location adjacent to an object with the greatest likelihood of generating sound. For example, as shown in FIG. 1C, the system 200 may recommend placing the microphone 50 adjacent to the piano 30 because the sound generation likelihood value 32 for the piano 30 may be greater than the sound generation likelihood values 36 and 46 for the piano player 34 and the audience members 44, respectively. In some implementations, the user 102 may not know which object in the physical environment is likely to generate sounds that need to be captured. As such, automatically selecting the placement location based on the locations of objects that are capable of generating sounds reduces the need for the user 102 to guess which object is likely to generate sounds that need to be captured.

As represented by block 320b, in some implementations, the set of one or more acoustical properties indicates a location of a musical instrument within the environment. In such implementations, determining the placement location for the microphone includes selecting the placement location based on the location of the musical instrument within the environment in order to capture sounds being generated by the musical instrument. In some implementations, the device recommends a placement location adjacent to the musical instrument in order to capture the sounds being generated by the musical instrument. For example, as shown in FIG. 1C, the system 200 recommends placing the microphone 50 adjacent to the piano 30. In some implementations, the physical environment includes multiple musical instruments, and the device recommends placing the microphone adjacent to the musical instrument that generates sound with the lowest amplitude. For example, as shown in FIG. 1L, the system 200 recommends placing the microphone 50 in front of the guitar instead of the drum set or the piano. In some implementations, the physical environment includes multiple musical instruments, and the device gives priority to a musical instrument that is centrally located. For example, referring to FIG. 1L, the system 200 may recommend placing the microphone 50 adjacent to the guitar instead of the piano or the drum set because the guitar is closer to a center of the physical environment than the piano or the drum set.

As represented by block 320c, in some implementations, the set of one or more acoustical properties indicates a location of a second microphone with a second pickup pattern. In such implementations, determining the placement location for the microphone includes selecting the placement location based on the location of the second microphone in order to reduce an overlap between the pickup pattern of the microphone and the second pickup pattern of the second microphone. For example, as shown in FIG. 1L, the system 200 recommends a placement location for the microphone 50 based on a location of an existing microphone. Automatically considering the location of an existing microphone allows the device to suggest a placement location that reduces overlap between the two microphones.

As represented by block 320d, in some implementations, the set of one or more acoustical properties are a function of material properties of the environment. In some implementations, the material properties indicate materials that exist in the environment. For example, the material properties may indicate materials of walls, a floor and/or furniture in the physical environment. In such implementations, determining the placement location for the microphone includes determining the placement location for the microphone based on the material properties of the environment. As discussed in relation to FIG. 1B, the system 200 may determine the sound absorptiveness/reflectiveness values 22, 26 and 42 based on the materials that the front wall 20, the side wall 24 and the bench 40, respectively, are composed of. As described in relation to FIG. 1C, the system 200 may recommend placing the microphone 50 on the left side of the piano 30, for example, because the side wall 24 may reflect too much sound and placing the microphone on the right side of the piano 30 may result in an excessive number of echoes being captured by the microphone 50. Automatically determining a placement location for the microphone based on the material properties of the environment helps ensure that a quality of the audio data captured by the microphone satisfies a threshold level of quality.

As represented by block 320c, in some implementations, the placement location allows the microphone to detect sounds from a threshold portion of the environment. In some implementations, the device recommends a placement location that allows the microphone to appropriately capture sounds being generated from the threshold portion of the environment. For example, the device may recommend placing the microphone at a location that allows the microphone to capture sounds originating from 80% of the physical environment.

In some implementations, the placement location results in a direct-to-reverberant ratio (DRR) that is less than a threshold DRR. Reducing the DRR value results in an audio capture with fewer echoes. In some implementations, the device generates a set of candidate placement locations and determines respective expected DRR values for the candidate placement locations. In such implementations, the device selects the candidate placement location with the smallest expected DRR value. More generally, in various implementations, the placement location results in a detected sound quality that satisfies a threshold sound quality. In some implementations, the device generates a set of candidate placement locations and determines respective expected quality values for audio data captured from the candidate placement locations. In such implementations, the device selects the candidate placement location with the greatest expected quality value.

As represented by block 320f, in some implementations, the pickup pattern indicates a directivity pattern of the microphone. For example, the pickup pattern may indicate whether the microphone is unidirectional, bidirectional, omnidirectional, a cardioid, a subcardioid, etc. In some implementations, the method 300 includes determining an identifier (e.g., a model or a serial number) that identifies the microphone, and retrieving the pickup pattern associated with the identifier from a datastore that stores pickup patterns for a plurality of microphones.

As represented by block 320g, in some implementations, determining the placement location includes automatically selecting the placement location from a plurality of candidate locations for placing the microphone based on respective scores associated with the plurality of candidate locations. In some implementations, the respective scores indicate expected qualities of the audio capture from the candidate locations, and the device selects the candidate location that is associated with the greatest expected quality. In some implementations, the respective scores indicate expected DRR values for the candidate locations, and the device selects the candidate location that is associated with the lowest DRR value. Automatically selecting the placement location reduces the need for a user of the device (e.g., an audio engineer) to perform an acoustic analysis of the physical environment in order to manually select the placement location for the microphone.

As represented by block 320h, in some implementations, determining the placement location includes determining a plurality of candidate locations for placing the microphone, displaying, on the display, respective visual indicators of the plurality of candidate locations for placing the microphone, and detecting a user selection of one of the respective visual indicators of the plurality of candidate locations that are displayed on the display. For example, as shown in FIG. 1K, the electronic device 100 displays visual indicators for two suggested locations that the user 102 can choose from.

As represented by block 330, in various implementations, the method 300 includes displaying, on the display, a representation of the environment and a visual indicator that is overlaid onto the representation of the environment in order to indicate the placement location for the microphone. For example, as shown in FIG. 1C, the electronic device 100 displays the visual indicator 150 for indicating a location where the microphone 50 can be placed. Displaying the visual indicator serves as a guide for placing the microphone in order to appropriately capture sounds originating from the physical environment. Displaying the visual indicator reduces the need for a user of the device (e.g., an audio engineer) to determine a placement location for the microphone based on trial-and-error. Incorrect placement of the microphone within the physical environment can result in unsuitable audio capture (e.g., sounds not being captured, the audio capture having too many echoes, etc.). Playback of unsuitable audio capture tends to detract from a user experience of the device and unnecessarily drain a battery of the electronic device. Hence, automatically determining a placement location for the microphone and displaying a visual indicator of the placement location tends to enhance a user experience of the device and conserve power by allowing the user to playback suitable audio capture.

As represented by block 330a, in some implementations, the visual indicator includes a balloon that matches a shape of the pickup pattern of the microphone. Overlaying the balloon onto the representation of the environment provides an indication of a directivity of the microphone and further allows the user to point the microphone in a correct direction.

As represented by block 330b, in some implementations, the method 300 includes generating a simulation that simulates sound capture by the microphone at the placement location and providing an option to play a sound recording that indicates a result of the simulation. In some implementations, the method 300 includes playing back a sound recording that simulates sound capture by the microphone from the placement location. For example, as shown in FIGS. 1I and 1J, the menu 162 includes the third option 162c for playing a simulation of sound capture from the location indicated by the visual indicator 150. In the example of FIGS. 1I and 1J, a user selection of the third option 162c triggers the electronic device 100 to play back the simulated audio output 172. Enabling the user to play a simulation of the sound capture before the user places the microphone at the recommended location allows the user to assess whether the recommended location appropriately captures sounds originating from the physical environment.

As represented by block 330c, in some implementations, the representation of the environment includes a pass-through representation of the environment and the visual indicator is overlaid onto the pass-through representation of the environment. For example, referring to FIG. 1C, the environment representation 110 may include a pass-through representation of the physical environment 10 shown in FIGS. 1A and 1B, and the visual indicator 150 may include an AR element that is overlaid onto the pass-through representation of the physical environment 10.

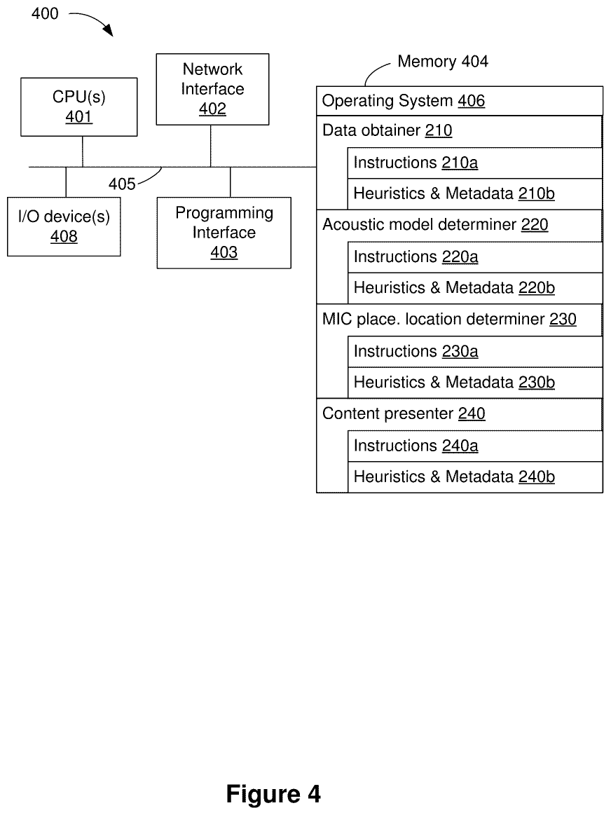

FIG. 4 is a block diagram of a device 400 in accordance with some implementations. In some implementations, the device 400 implements the electronic device 100 shown in FIGS. 1A-1L and/or the system 200 shown in FIGS. 1A-IL. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the one or more I/O devices 408 include a display for displaying the environment representation 110 shown in FIG. 1C. In some implementations, the display includes an extended reality (XR) display. In some implementations, the display includes an opaque display. Alternatively, in some implementations, the display includes an optical see-through display. In some implementations, the one or more I/O devices 408 include an environmental sensor for capturing the environmental data 212 shown in FIG. 2. For example, the one or more I/O devices 408 include an image sensor (e.g., a visible light camera and/or an infrared light camera) for capturing the image data 212a and/or a depth sensor (e.g., a depth camera) for capturing the depth data 212b shown in FIG. 2.

In some implementations, the memory 404 or the non-transitory computer readable storage medium of the memory 404 stores the following programs, modules and data structures, or a subset thereof including an optional operating system 406, the data obtainer 210, the acoustic model determiner 220, the placement determiner 230 and the content presenter 240.

In various implementations, the data obtainer 210 includes instructions 210a, and heuristics and metadata 210b for obtaining the environmental data 212 and/or the microphone information 214 shown in FIG. 2. In some implementations, the acoustic model determiner 220 includes instructions 220a, and heuristics and metadata 220b for determining an acoustic model of an environment (e.g., the acoustic model 60 shown in FIG. 1B and/or the acoustic model 222 shown in FIG. 2). In some implementations, the placement determiner 230 includes instructions 230a, and heuristics and metadata 230b for determining a placement location for a microphone based on the acoustic model and a pickup pattern of the microphone (e.g., the placement location 232 shown in FIG. 2 and/or the placement location indicated by the visual indicator 150 shown in FIG. 1C). In some implementations, the content presenter 240 includes instructions 240a, and heuristics and metadata 240b for displaying a visual indicator to indicate the placement location for the microphone (e.g., the visual indicator 150 shown in FIG. 1C, the visual indicator 150′ shown in FIG. 1H, the visual indicators for the suggested microphone locations 150a and 150b shown in FIG. 1K, the visual indicator 192 shown in FIG. 1L and/or the visual indicator 244 shown in FIG. 2).

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a display, an environmental sensor, a non-transitory memory and one or more processors coupled with the display, the environmental sensor and the non-transitory memory:
obtaining an acoustic model of an environment, wherein the acoustic model indicates a set of one or more acoustical properties of the environment;
determining a placement location for a microphone within the environment based on the set of one or more acoustical properties of the environment and a pickup pattern of the microphone; and
displaying, on the display, a representation of the environment and a visual indicator that is overlaid onto the representation of the environment in order to indicate the placement location for the microphone.

2. The method of claim 1, wherein obtaining the acoustic model comprises:
obtaining a visual mesh that indicates dimensions of the environment and placement of objects in the environment; and
generating the acoustic model based on the visual mesh of the environment.

3. The method of claim 1, wherein the set of one or more acoustical properties indicates how sound propagates within the environment; and
wherein determining the placement location for the microphone comprises selecting the placement location based on how the sound propagates within the environment.

4. The method of claim 1, wherein the set of one or more acoustical properties indicates respective locations of objects that are capable of generating sounds; and
wherein determining the placement location for the microphone comprises selecting the placement location based on the respective locations of the objects that are capable of generating the sounds in order to capture the sounds that the objects are capable of generating.

5. The method of claim 1, wherein the set of one or more acoustical properties indicates a location of a musical instrument within the environment; and
wherein determining the placement location for the microphone comprises selecting the placement location based on the location of the musical instrument within the environment in order to capture sounds being generated by the musical instrument.

6. The method of claim 1, wherein the set of one or more acoustical properties indicates a location of a second microphone with a second pickup pattern; and
wherein determining the placement location for the microphone comprises selecting the placement location based on the location of the second microphone in order to reduce an overlap between the pickup pattern of the microphone and the second pickup pattern of the second microphone.

7. The method of claim 1, wherein the set of one or more acoustical properties are a function of material properties of the environment; and
wherein determining the placement location for the microphone comprises determining the placement location for the microphone based on the material properties of the environment.

8. The method of claim 1, wherein the placement location allows the microphone to detect sounds from a threshold portion of the environment.

9. The method of claim 1, wherein the placement location results in a direct-to-reverberant ratio (DRR) that is less than a threshold DRR.

10. The method of claim 1, wherein the placement location results in a detected sound quality that satisfies a threshold sound quality.

11. The method of claim 1, wherein the pickup pattern indicates a directivity pattern of the microphone.

12. The method of claim 1, further comprising:
determining an identifier that identifies the microphone; and
retrieving the pickup pattern associated with the identifier from a datastore that stores pickup patterns for a plurality of microphones.

13. The method of claim 1, wherein determining the placement location comprises:
automatically selecting the placement location from a plurality of candidate locations for placing the microphone based on respective scores associated with the plurality of candidate locations.

14. The method of claim 1, wherein determining the placement location comprises:
determining a plurality of candidate locations for placing the microphone;
displaying, on the display, respective visual indicators of the plurality of candidate locations for placing the microphone; and
detecting a user selection of one of the respective visual indicators of the plurality of candidate locations that are displayed on the display.

15. The method of claim 1, further comprising:
generating a simulation that simulates sound capture by the microphone at the placement location and providing an option to play a sound recording that indicates a result of the simulation.

16. The method of claim 1, further comprising:
playing back a sound recording that simulates sound capture by the microphone from the placement location.

17. The method of claim 1, wherein the representation of the environment includes a pass-through representation of the environment and the visual indicator is overlaid onto the pass-through representation of the environment.

18. A device comprising:
a display;
an environmental sensor;
one or more processors;
a non-transitory memory; and
one or more programs stored in the non-transitory memory, which, when executed by the one or more processors, cause the device to:
obtain an acoustic model of an environment, wherein the acoustic model indicates a set of one or more acoustical properties of the environment;
determine a placement location for a microphone within the environment based on the set of one or more acoustical properties of the environment and a pickup pattern of the microphone; and
display, on the display, a representation of the environment and a visual indicator that is overlaid onto the representation of the environment in order to indicate the placement location for the microphone.

19. The device of claim 18, wherein obtaining the acoustic model comprises:
obtaining a visual mesh that indicates dimensions of the environment and placement of objects in the environment; and
generating the acoustic model based on the visual mesh of the environment.

20. A non-transitory memory storing one or more programs, which, when executed by one or more processors of a device with an environmental sensor and a display, cause the device to:
obtain an acoustic model of an environment, wherein the acoustic model indicates a set of one or more acoustical properties of the environment;
determine a placement location for a microphone within the environment based on the set of one or more acoustical properties of the environment and a pickup pattern of the microphone; and
display, on the display, a representation of the environment and a visual indicator that is overlaid onto the representation of the environment in order to indicate the placement location for the microphone.
